(19) United States
(12) Patent Application Publication
(10) Pub. No.: US 2025/0173588 A1
(43) Pub. Date: May 29, 2025

(54) Logic Model Preparation Support Device, Logic Model Preparation Support Method, and Logic Model Preparation Support Program

(71) Applicant: HITACHI, LTD., Chiyoda-ku, Tokyo (JP)

(72) Inventors: Misa MIYAKOSHI, Tokyo (JP); Junichi MIYAKOSHI, Tokyo (JP)

(21) Appl. No.: 18/834,497

(22) PCT Filed: Mar. 14, 2022
(86) PCT No.: PCT/JP2022/011422

§ 371 Date: Jul. 30, 2024

(51) Int. Cl. G06N 5/04

(52) U.S. Cl. CPC G06N 5/04

(57) ABSTRACT

A logic model preparation support device includes: a storage unit configured to store a logic model being a network structure including at least one node having an index and an edge indicating a connection of indexes indicated by two of the at least one node; an input unit configured to input a first node and a first edge; a generation unit configured to generate a first logic model based on a first node and a first edge input by the input unit; an identification unit configured to identify a similarity index similar to a first index of the first node from the logic model when the first node in a first logic model generated by the generation unit is specified; and an output unit configured to output a similarity index identified by the identification unit.

### TECHNICAL FIELD

The present invention relates to a logic model preparation support device, a logic model preparation support method, and a logic model preparation support program that support the preparation of a logic model.

### BACKGROUND ART

PTL 1 below discloses a communication support system using a communication network such as the Internet. This communication support system supports the convergence of online discussion, classifies information, which is input to an email or a text box, appearing in the discussion into problems and solutions in a server, and generates a logic model.

### CITATION LIST

### Patent Literature

PTL 1: JP 2005-056377 A

### SUMMARY OF INVENTION

### Technical Problem

However, in PTL 1, it is not considered to express logic models that are opinions of users having different values who discuss the same topic. For this reason, in the communication support system of PTL 1, logic models of different values cannot be individually generated, and even if a difference in opinion occurs, the logic models may be aggregated and presented into a logic model of a specific user.

An object of the present invention is to improve the efficiency of preparing a logic model.

### Solution to Problem

A logic model preparation support device according to one aspect of the invention disclosed in the present application includes: a storage unit configured to store a logic model being a network structure including at least one node having an index and an edge indicating a connection of indexes indicated by two of the at least one node; an input unit configured to input a first node and a first edge; a generation unit configured to generate a first logic model based on a first node and a first edge input by the input unit; an identification unit configured to identify a similarity index similar to a first index of the first node from the logic model when the first node in a first logic model generated by the generation unit is specified; and an output unit configured to output a similarity index identified by the identification unit.

### Advantageous Effects of Invention

According to the representative embodiment of the present invention, it is possible to improve the efficiency of preparing the logic model. Problems, configurations, and effects other than those described above will be clarified by the following description of embodiments.

### BRIEF DESCRIPTION OF DRAWINGS

FIG. 1 is an explanatory diagram showing a system configuration example of a logic model preparation system.

FIG. 2 is an explanatory block diagram showing a hardware configuration example of a computer.

FIG. 3 is an explanatory diagram showing an example of the logic model DB.

FIG. 4 is an explanatory diagram showing an example of the logic model index DB.

FIG. 5 is a block diagram showing a functional configuration example of the logic model preparation support device.

FIG. 6 is an explanatory diagram showing an example of a lobby screen when the logic model preparation support device is used.

FIG. 7 is an explanatory diagram showing an input screen example of the terminal.

FIG. 8 is an explanatory diagram showing a first example of the logic model.

FIG. 9 is an explanatory diagram showing a display example 1 of the logic model preparation screen on the terminal.

FIG. 10 is an explanatory diagram showing an example of the node candidate list.

FIG. 11 is an explanatory diagram showing a display example 2 of the logic model preparation screen on the terminal.

FIG. 12 is an explanatory diagram showing a second example of the logic model.

FIG. 13 is an explanatory diagram showing a third example of the logic model.

FIG. 14 is an explanatory diagram showing a fourth example of the logic model.

FIG. 15 is an explanatory diagram showing a fifth example of the logic model.

### DESCRIPTION OF EMBODIMENTS

### Logic Model

The logic model is a model indicating a logical network structure for understanding an object. For example, when the target is measures, the logic model is a model indicating a logical network structure of measures that clearly indicates a logical causal relationship until certain measures achieve the purpose thereof. It is represented by nodes, edges, and layers. The node indicates, for example, an index to be a factor affecting the social impact such as the satisfaction level of the resident. The edge indicates a connection between the indexes.

The logical network structure is layered by combining nodes and edges. This layer includes input, activity, output, outcome, and impact. The node belonging to the input indicates an index related to a physical resource such as a person, an object, or money. The node belonging to the activity indicates an index related to the content in which the physical resource of the node belonging to the input actually performs the activity. The node belonging to the output indicates an index related to a profit obtained by the activity of the node belonging to the activity, an object to be produced, and a service. The node belonging to the outcome indicates an index related to a change or an effect caused by a profit, an object to be produced, or a service. The node belonging to the impact is an index related to a social or environmental outcome proposed in SDGs or the like caused by a change or an effect. It should be noted that each of the input, activity, output, outcome, and impact may have multiple layers therein. In the present embodiment, a logic model preparation system that prepares such a logic model will be described.

### System Configuration Example

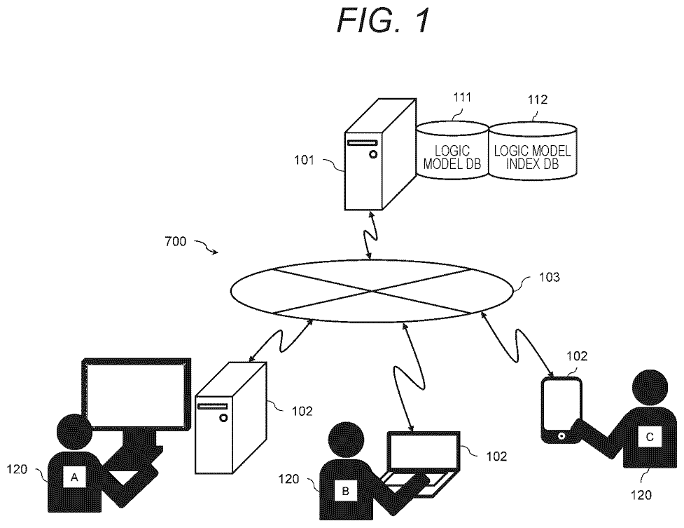

FIG. 1 is an explanatory diagram showing a system configuration example of a logic model preparation system. The logic model preparation system 100 includes a logic model preparation support device 101 that functions as a server and a terminal 102 of the user 120. The logic model preparation support device 101 and the terminal 102 are communicably connected via a network 103 such as the Internet, a local area network (LAN), or a wide area network (WAN).

The logic model preparation support device 101 is a computer that prepares a logic model for the user 120 to logically examine the influence on society based on some activity such as a community activity or a corporate investment activity. The number of users 120 may be one or plural.

The logic model preparation support device 101 includes a logic model DB111 that stores data of a logic model prepared in the past and a logic model index DB112 that stores an index necessary for configuring the logic model. The logic model DB111 and the logic model index DB112 may be stored in another computer or a network hard disk communicably connected to the logic model preparation support device 101 via the network 103.

### Hardware Configuration Example of Computer (Logic Model Preparation Support Device 101 and Terminal 102)

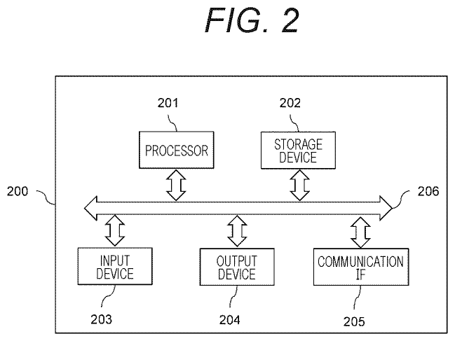

FIG. 2 is an explanatory block diagram showing a hardware configuration example of a computer. The computer 200 includes a processor 201, a storage device 202, an input device 203, an output device 204, and a communication interface (communication IF) 205. The processor 201, the storage device 202, the input device 203, the output device 204, and the communication IF205 are connected by a bus 206. The processor 201 controls the computer 200. The storage device 202 serves as a work area of the processor 201. In addition, the storage device 202 is a non-transitory or transitory storage medium that stores various programs and data. Examples of the storage device 202 include a read only memory (ROM), a random access memory (RAM), a hard disk drive (HDD), a flash memory, and a solid state drive (SSD). The input device 203 inputs data. Examples of the input device 203 include a keyboard, a mouse, a touch panel, a numeric keypad, a scanner, and a pen tablet. The output device 204 outputs data. Examples of the output device 204 include a display, a printer, a speaker, and a projector. The communication IF205 is connected to the network 103 to transmit and receive data.

### Logic Model DB101

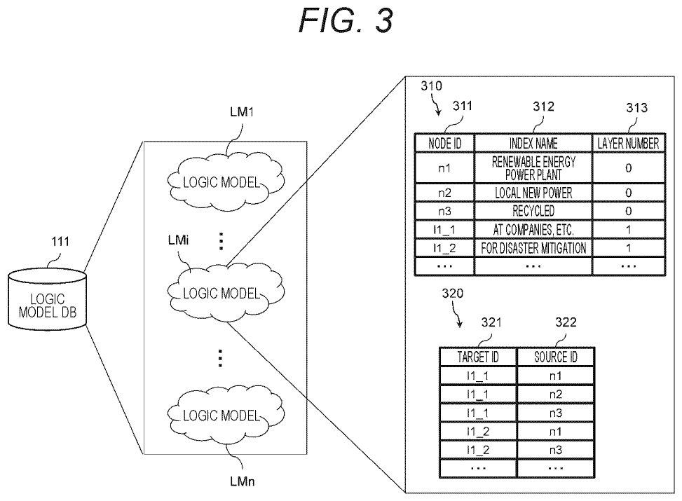

FIG. 3 is an explanatory diagram showing an example of the logic model DB101. The logic model DB101 stores logic models LM1 to LMn (n is an integer of 1 or more) prepared by the logic model preparation support device 101 in the past. When the logic models LM1 to LMn are not distinguished, they are expressed as a logic model LMi (i is an integer satisfying 1≤i≤n).

The logic model LMi includes a node table 310 and an edge table 320. The node table 310 has a node ID311, an index name 312, and a layer number 313 as fields. The node ID311 is identification information for uniquely specifying a node. The index name 312 is the name of an index indicated by the node specified by the node ID311. The layer number 313 is a number indicating a layer to which the node belongs, and for example, “0” indicates the input, “1” indicates the activity, “2” indicates the output, “3” indicates the outcome, and “4” indicates the impact. When there is a layer inside a layer, the layer inside is expressed using branch numbers such as “1-1” and “1-2”. Each entry of the node table 310 defines a node.

The edge table 320 has a target ID321 and a source ID as fields. The target ID321 is the node ID311 of the node to be the target. The source ID322 is the node ID311 of the node to be the source. The layer number 313 of the target is a layer number 313 larger than the layer number 313 of the source. Each entry of the edge table 320 defines an edge.

### Logic Model Index DB122

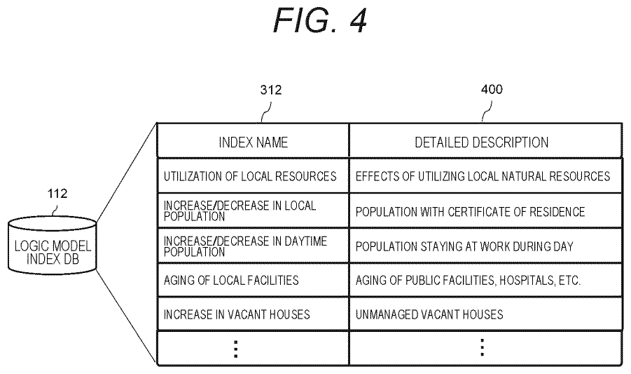

FIG. 4 is an explanatory diagram showing an example of the logic model index DB122. The logic model index DB122 is a database that registers the index name 312 of the logic model LMi. The logic model index DB122 has an index name 312 and a detailed description 400 as fields. The detailed description 400 is information related to the index name 312. Specifically, for example, the detailed description 400 is a character string describing the index name 312 in detail, and can be registered from the terminal 102 during or after preparation of the logic model LMi.

### Functional Configuration Example of Logic Model Preparation Support Device 101

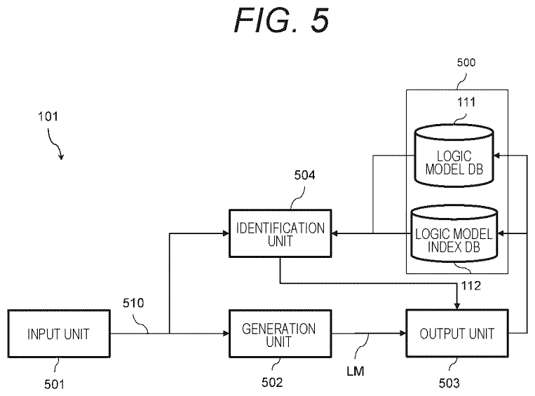

FIG. 5 is a block diagram showing a functional configuration example of the logic model preparation support device 101. The logic model preparation support device 101 includes a storage unit 500, an input unit 501, a generation unit 502, an output unit 503, and an identification unit 504. Specifically, the storage unit 500 is a function implemented by, for example, the storage device 202 shown in FIG. 2 or a storage device of another computer accessible by the logic model preparation support device 101. Specifically, the input unit 501, the generation unit 502, the output unit 503, and the identification unit 504 are functions implemented by causing the processor 201 to execute a program stored in the storage device 202 shown in FIG. 2, for example.

The storage unit 500 stores the logic model DB111 and the logic model index DB112 described above.

The input unit 501 receives inputs of nodes and edges from the input device 203. The node is an entry of the node table 310. The edge is an entry of the edge table 320. The input unit 501 outputs the node and the edge as the input information 510 to the generation unit 502 and the identification unit 504.

The generation unit 502 generates the logic model LM based on the input information 510 and outputs the logic model LM to the output unit 503.

The output unit 503 outputs the logic model LM generated by the generation unit 502 to the terminal 102 through the output device 204 or the communication IF205. In addition, the output unit 503 stores the logic model LM in the logic model DB111, and stores the index name 312 and the detailed description 400 of the node constituting the logic model LM in the logic model index DB112.

The identification unit 504 calculates the similarity between the two index names 312. One of the two index names 312 is the index name 312 indicated by the input information 510 or the node in the logic model LM, and the other is the index name 312 indicated by the node of the logic model LMi in the logic model DB102 or the index name 312 in the logic model index DB112.

Specifically, for example, the identification unit 504 performs morphological analysis on each of the two index names 312, and generates a feature vector by TF-IDF for each of the two index names 312. Then, the identification unit 504 calculates the cosine similarity between both the feature vectors. The identification unit 504 determines that the two index names 312 are similar if the cosine similarity is greater than or equal to a threshold value larger than 0.

In addition, the identification unit 504 may calculate the cosine similarity between the index name 312 indicated by the node in the logic model LM and each of the index names 312 indicated by the nodes in the logic model LMi, but may narrow down the logic model LMi prior to the calculation of the cosine similarity.

For example, each of the logic models LM1 to LMn of the logic model DB111 has an identifier for identifying a field and can be grouped for each field. The identification unit 504 divides the logic models LM1 to LMn of the logic model DB111 by field, uses the logic model LMi belonging to the field as training data for each field, uses whether the logic model LMi has been used for the measure as correct answer data, learns by the graph neural network, and generates a learning model for each field. The learning model is stored in the storage device 202.

Next, the identification unit 504 inputs the generated logic model LM to the learning model of each field and outputs the predicted value. When the predicted value is data indicating that the logic model LM is used for the measure, the identification unit 504 selects the logic model LMi used for training the learning model that has output the predicted value as the calculation target of cosine similarity.

It should be noted that the identification unit 504 outputs the similarity calculation result (index name 312) to the output unit 503. Accordingly, the output unit 503 can output the similarity calculation result to the output device 204 together with the logic model LM.

### Lobby Screen Example

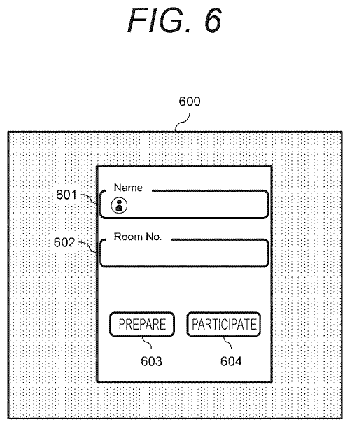

FIG. 6 is an explanatory diagram showing an example of a lobby screen when the logic model preparation support device 101 is used. On the lobby screen 600, it is possible to input a participant name input field 601 when participating in the logic model preparation support device 101 and a room number input field 602 to participate in. The room preparation button 603 enables a room to be newly prepared, and the room participation button 604 enables participating in the already prepared room.

### Input Screen Example

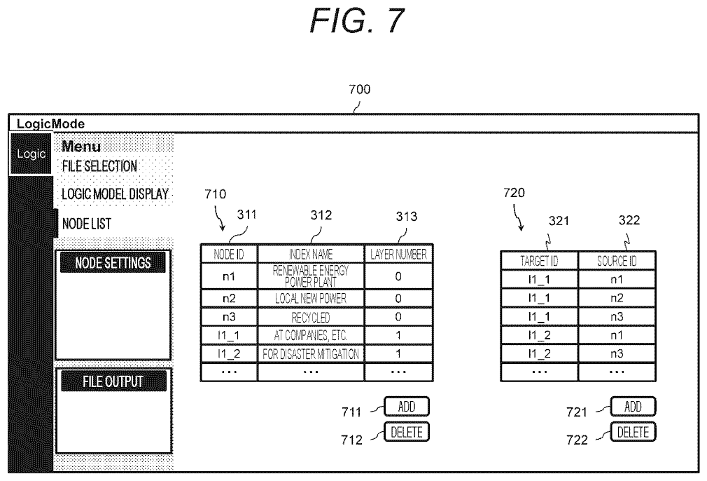

FIG. 7 is an explanatory diagram showing an input screen example of the terminal 102. The input screen 700 is displayed on the terminal 102. The input screen 700 displays node information 710, an add button 711, a delete button 712, edge information 720, an add button 721, and a delete button 722.

The node information 710 includes an entry (node ID311, index name 312, and layer number 313) of a newly registered node. The add button 711 is a user interface for adding an entry to the node information 710 by being depressed when the entry is prepared in the node information 710. The delete button 712 is a user interface for deleting the entry of the node information 710 specified by the cursor from the node information 710.

The edge information 720 includes an entry (target ID321, and source ID322) of a newly registered edge. The add button 721 is a user interface for adding an entry to the edge information 720 by being depressed when the entry is prepared in the edge information 720. The delete button 712 is a user interface for deleting the entry of the edge information 720 specified by the cursor from the edge information 720.

### Logic Model Example

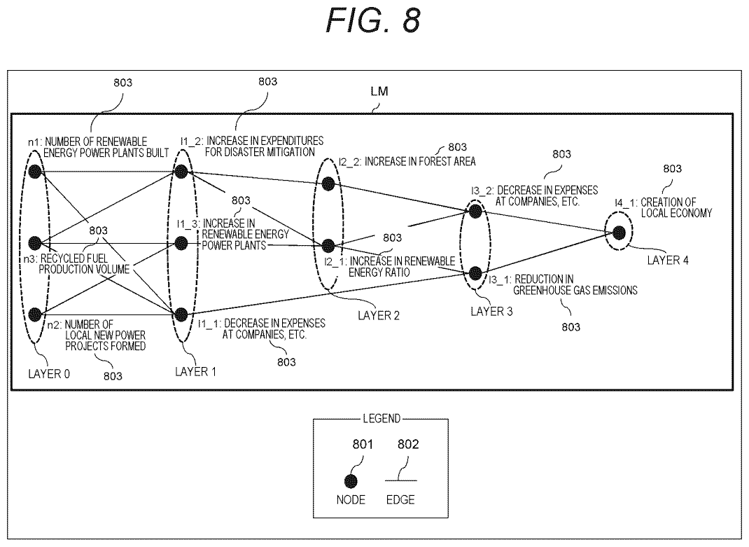

FIG. 8 is an explanatory diagram showing a first example of the logic model LM. The logic model LM is generated by the generation unit 502 using the node information 710 and the edge information 720 input on the input screen 700. The entry of the node information 710 is displayed by a black circle figure as the node 801 indicating the index. The node ID311 and the index name 312 are displayed near the corresponding node 701 as the label information 803. The entry of the edge information 720 is displayed by a line segment as an edge 802 indicating a linkage. In addition, the layer identified by the layer number 313 is displayed by an elliptical figure of a black broken line.

### Logic Model Preparation Screen Example

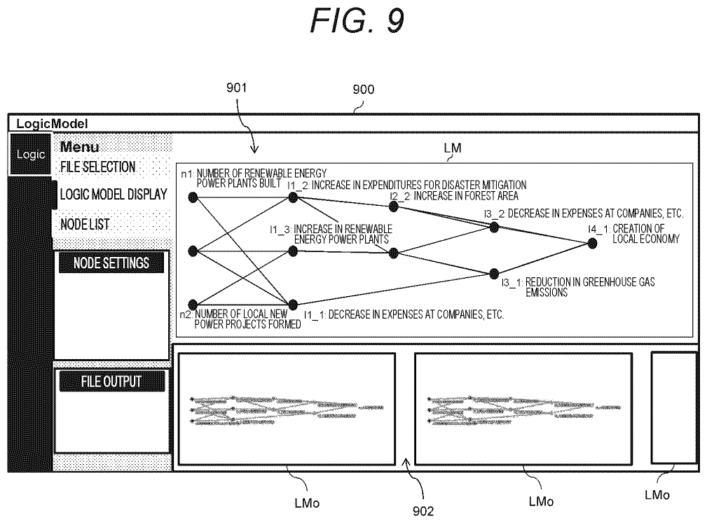

FIG. 9 is an explanatory diagram showing a display example 1 of the logic model preparation screen on the terminal 102. The logic model preparation screen 900 has a first display area 901 and a second display area 902. In the first display area 901, the logic model LM generated by the generation unit 502 based on the input information 510 input by the user 120 is displayed.

In the second display area 902, the logic model LMo generated by the generation unit 502 based on the input information 510 input by another user 120 is displayed. As described above, when a plurality of users 120 are preparing the logic models LM and LMo, the logic model LM of the user and the logic model LMo of the other user are displayed on the logic model preparation screen 900 in each of their terminals 102.

### Node Candidate List

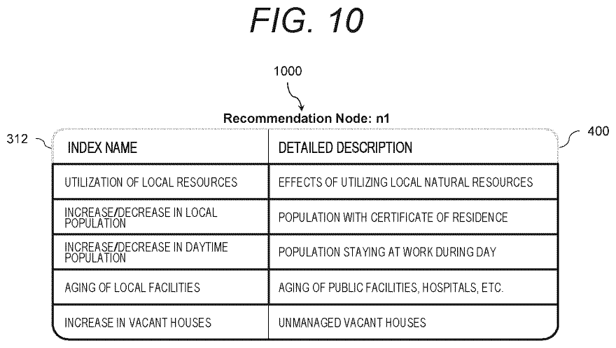

FIG. 10 is an explanatory diagram showing an example of the node candidate list. The node candidate list 1000 is a list displayed when a node 801 is newly added or the index name 312 of the prepared node 801 is changed. The node candidate list 1000 includes an index name 312 and a detailed description 400. FIG. 10 is a node candidate list 1000 for the node 801 whose node ID311 is “n1”.

Specifically, for example, when the input unit 501 receives specification of the node 801 by the operation of the user 120, the identification unit 504 calculates cosine similarity between the index name 312 of the specified node 801 and the index name 312 indicated by the node 801 of the logic model LMi in the logic model DB102 or the index name 312 in the logic model index DB112. Then, the output unit 503 outputs, as the node candidate list 1000, the index names 312 whose cosine similarity is equal to or greater than the threshold value or the top m-th (m is an integer of 1 or more) and the detailed description 400 thereof in a displayable manner to the terminal 102 of the user 120 who has specified the node 801.

In addition, for example, when the input unit 501 receives the specification of the edge 802 by the operation of the user 120, the identification unit 504 calculates cosine similarity between the index name 312 of at least one node 801 of the nodes 801 at both ends connected by the specified edge 802 and the index name 312 indicated by the node 801 of the logic model LMi in the logic model DB102 or the index name 312 in the logic model index DB112. Then, the output unit 503 may output, as the node candidate list 1000, the index names 312 whose cosine similarity is equal to or greater than the threshold value or the top m-th (m is an integer of 1 or more) and the detailed description 400 thereof in a displayable manner to the terminal 102 of the user 120 who has specified the at least one node 801.

### Node Candidate List Display Screen Example

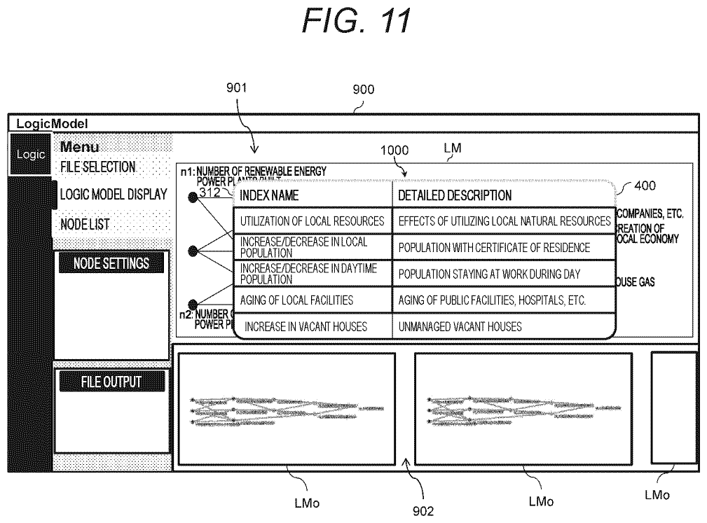

FIG. 11 is an explanatory diagram showing a display example 2 of the logic model preparation screen 900 on the terminal 102. FIG. 11 shows an example in which the node candidate list 1000 is displayed when the node 801 is specified by a user operation on the logic model preparation screen 900.

### Logic Model Display Example in Which Color of Node is Changed by Layer

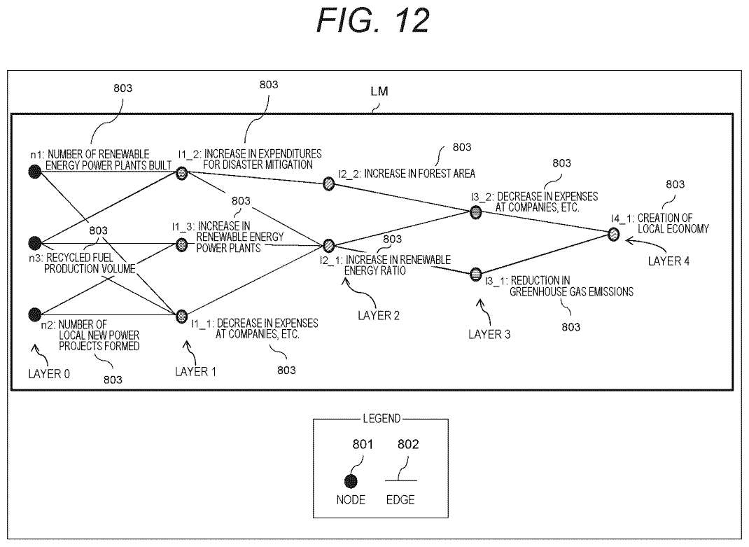

FIG. 12 is an explanatory diagram showing a second example of the logic model LM. FIG. 12 is an explanatory diagram showing a display example in which the color of the node 801 of the logic model LM is changed by layer. As described above, the visibility can be improved by making the color of the node 801 different by layer.

### Dissimilarity Display Example with Other User in Node Highlighting

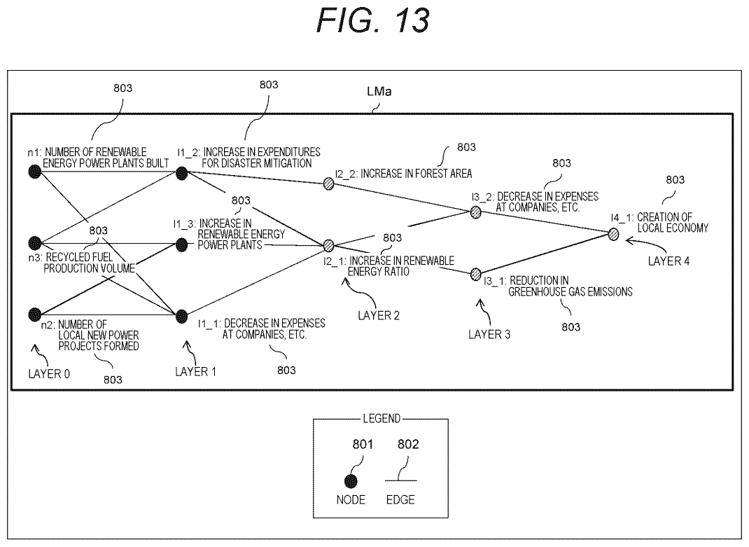

FIG. 13 is an explanatory diagram showing a third example of the logic model LM. FIG. 13 shows an example in which when the logic model preparation support device 101 is used by a plurality of users 120, a node 801 having dissimilarity between a logic model LM (hereinafter, LMa) of a user A) and a logic model user 120 (as an example, a LM (hereinafter, LMb) of another user 120 (as an example, a user B) is highlighted. It should be noted that, here, a dissimilarity display example on the terminal 102 of the user A will be described.

For example, the identification unit 504 calculates cosine similarity between each of the index names 312 of the nodes 801 of the logic model LMa prepared by the user A and the index name 312 of each of the nodes 801 of the logic model LMb prepared by the user B. For each of the index names 312 of the nodes 801 of the logic model LMa, the identification unit 504 determines whether the index name 312 having the cosine similarity equal to or greater than the threshold value is in the logic model LMb. Among the nodes 801 of the logic model LMa, the identification unit 504 determines, as the dissimilarity display target node 801, a node 801 of the logic model LMa in which there is no index name 312 having the cosine similarity equal to or greater than the threshold value in the logic model LMb.

The output unit 503 outputs the dissimilarity display target node 801 to the terminal 102 of the user A so as to be able to be highlighted so as to be distinguishable from the node 801 that is not the dissimilarity display target in the logic model LMa.

In FIG. 13, for example, the output unit 503 displays the color of the dissimilarity display target node 801 in a color (hatching in FIG. 13) different from the color of the node 801 (black) that is not the dissimilarity display target in the logic model LMa.

In addition, the output unit 503 may display the size of the dissimilarity display target node 801 in a size different from the size of the node 801 that is not the dissimilarity display target in the logic model LMa.

In addition, the output unit 503 may display the color and the size of the dissimilarity display target node 801 in a color and a size different from the color and the size of the node 801 that is not the dissimilarity display target in the logic model LMa.

In addition, as viewed from the terminal 102 of the user B, for each of the index names 312 of the nodes 801 of the logic model LMb, the identification unit 504 determines whether the index name 312 having the cosine similarity equal to or greater than the threshold value is in the logic model LMa. Among the nodes 801 of the logic model LMb, the identification unit 504 determines, as the dissimilarity display target node 801, a node 801 of the logic model LMb in which the index name 312 having the cosine similarity equal to or higher than the threshold value is not present in the logic model LMa.

The output unit 503 outputs the dissimilarity display target node 801 to the terminal 102 of the user B so as to be able to be highlighted so as to be distinguishable from the node 801 that is not the dissimilarity display target in the logic model LMb.

### Dissimilarity Display Example with Other User in Edge Highlighting

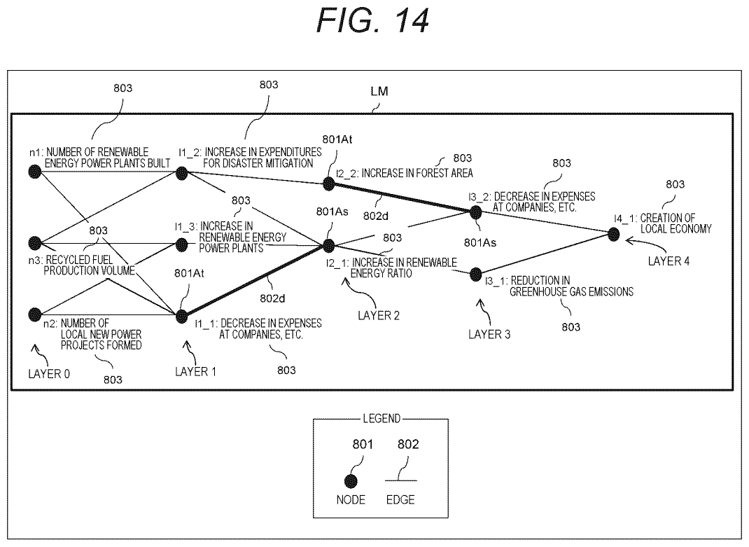

FIG. 14 is an explanatory diagram showing a fourth example of the logic model LM. FIG. 14 shows an example in which when the logic model preparation support device 101 is used by a plurality of users 120, an edge 802 having dissimilarity between the logic model LMa of the user A and the logic model LMb of the user B is highlighted. It should be noted that, here, a dissimilarity display example on the terminal 102 of the user A will be described.

For example, the identification unit 504 calculates cosine similarity between each of the index names 312 of the nodes 801 of the logic model LMa prepared by the user A and the index name 312 of each of the nodes 801 of the logic model LMb prepared by the user B. For each of the index names 312 of the nodes 801 of the logic model LMa, the identification unit 504 determines whether the index name 312 having the cosine similarity equal to or greater than the threshold value is in the logic model LMb.

Among the nodes 801 of the logic model LMa, the identification unit 504 identifies the node 801 of the logic model LMa based on the cosine similarity. The node 801 of the logic model LMa is referred to as a source node 801As. Specifically, for example, among the nodes 801 of the logic model LMa, the identification unit 504 identifies the node 801 indicated by the index name 312 having the cosine similarity equal to or greater than the threshold value. In this case, the identification unit 504 identifies, as the source node 801Bs, the node 801 of the logic model LMb in which the cosine similarity with the index name 312 of the source node 801As is equal to or greater than the threshold value.

Among the nodes 801 of the logic model LMa, the identification unit 504 identifies the node 801 indicated by the index name 312 having the cosine similarity equal to or greater than the threshold value. The node 801 of the logic model LMa is referred to as a source node 801As. In addition, the node 801 of the logic model LMb in which the cosine similarity with the index name 312 of the source node 801As is equal to or greater than the threshold value is referred to as the source node 801Bs.

The identification unit 504 identifies a node 801 linked to the source node 801As in the logic model LMa. This node 801 is referred to as a target node 801At. Similarly, the identification unit 504 identifies a node 801 linked to the source node 801Bs in the logic model LMb. This node 801 is referred to as a target node 801Bt.

The identification unit 504 calculates cosine similarity between the index name 312 of the target node 801At and the index name 312 of the target node 801Bt, and determines whether the cosine similarity is equal to or greater than a threshold value. When the cosine similarity between the index name 312 of the target node 801At and the index name 312 of the target node 801Bt is not equal to or greater than the threshold value, the identification unit 504 determines the edge 802 connecting the source node 801As and the target node 801At as the dissimilarity display target edge 802 (hereinafter, 802d).

The output unit 503 outputs the dissimilarity display target edge 802d to the terminal 102 of the user A so as to be able to be highlighted so as to be distinguishable from the edge 802 that is not the dissimilarity display target in the logic model LMa.

In FIG. 14, for example, in the logic model LMa, the output unit 503 displays the thickness of the dissimilarity display target edge 802d with a thickness different from that of the edge 802 that is not the dissimilarity display target.

In addition, in the logic model LMa, the output unit 503 may display the color of the dissimilarity display target edge 802d with a color different from that of the edge 802 that is not the dissimilarity display target.

In addition, the output unit 503 may display the color and the thickness of the dissimilarity display target edge 802d in a color and a thickness different from the color and the size of the edge 802 that is not the dissimilarity display target in the logic model LMa.

In addition, as viewed from the terminal 102 of the user B, among the nodes 801 of the logic model LMb, the identification unit 504 identifies the node 801 indicated by the index name 312 having the cosine similarity equal to or greater than the threshold value. The node 801 of the logic model LMb is referred to as a source node 801Bs. In addition, the node 801 of the logic model LMa in which the cosine similarity with the index name 312 of the source node 801Bs is equal to or greater than the threshold value is referred to as the source node 801As.

The identification unit 504 identifies a node 801 linked to the source node 801Bs in the logic model LMb. This node 801 is referred to as a target node 801Bt. Similarly, the identification unit 504 identifies a node 801 linked to the source node 801As in the logic model LMa. This node 801 is referred to as a target node 801At.

The identification unit 504 calculates cosine similarity between the index name 312 of the target node 801Bt and the index name 312 of the target node 801At, and determines whether the cosine similarity is equal to or greater than a threshold value. When the cosine similarity between the index name 312 of the target node 801Bt and the index name 312 of the target node 801At is not equal to or greater than the threshold value, the identification unit 504 determines the edge 802 connecting the source node 801Bs and the target node 801Bt as the dissimilarity display target edge 802d.

The output unit 503 outputs the dissimilarity display target edge 802d to the terminal 102 of the user B so as to be able to be highlighted so as to be distinguishable from the edge 802 that is not the dissimilarity display target in the logic model LMb.

It should be noted that in FIG. 14, the identification unit 504 identifies the source node 801As and the source node 801Bs whose cosine similarity with the index name 312 of the source node 801As is equal to or greater than the threshold value, and then identifies the dissimilarity display target edge 802d connecting the source node 801As and the target node 801At when the cosine similarity between the index name 312 of the target node 801At and the index name 312 of the target node 801Bt is not equal to or greater than the threshold value.

On the other hand, the identification unit 504 may identify the target node 801At and the target node 801Bt whose cosine similarity with the index name 312 of the target node 801At is equal to or greater than the threshold value, and then may identify the dissimilarity display target edge 802d connecting the target node 801At and the source node 801As when the cosine similarity between the index name 312 of the source node 801As and the index name 312 of the source node 801Bs is not equal to or greater than the threshold value.

In addition, when identifying the source node 801As based on the cosine similarity among the nodes 801 of the logic model LMa, the identification unit 504 identifies, as the source node 801As, the node 801 indicated by the index name 312 whose cosine similarity is equal to or greater than the threshold value among the nodes 801 of the logic model LMa.

On the other hand, the identification unit 504 may identify the node 801 indicated by the index name 312 whose cosine similarity is not equal to or greater than the threshold value among the nodes 801 of the logic model LMa as the source node 801As. In this case, the identification unit 504 identifies, as the source node 801Bs, the node 801 of the logic model LMb in which the cosine similarity with the index name 312 of the source node 801As is not equal to or greater than the threshold value.

Accordingly, the edge 802 connecting the source node 801As of the logic model LMa in which the cosine similarity with the index name 312 of the source node 801Bs is not equal to or greater than the threshold value and the target node 801At of the logic model LMa in which the cosine similarity with the index name 312 of the target node 801Bt is not equal to or greater than the threshold value is identified as the dissimilarity display target edge 802d and is output to the terminal 102 of the user A in a displayable manner.

Similarly, the edge 802 connecting the source node 801Bs of the logic model LMb in which the cosine similarity with the index name 312 of the source node 801As is not equal to or greater than the threshold value and the target node 801Bt of the logic model LMb in which the cosine similarity with the index name 312 of the target node 801At is not equal to or greater than the threshold value is identified the dissimilarity display target edge 802d and is output to the terminal 102 of the user A in a displayable manner.

### Highlighting of Node and Edge

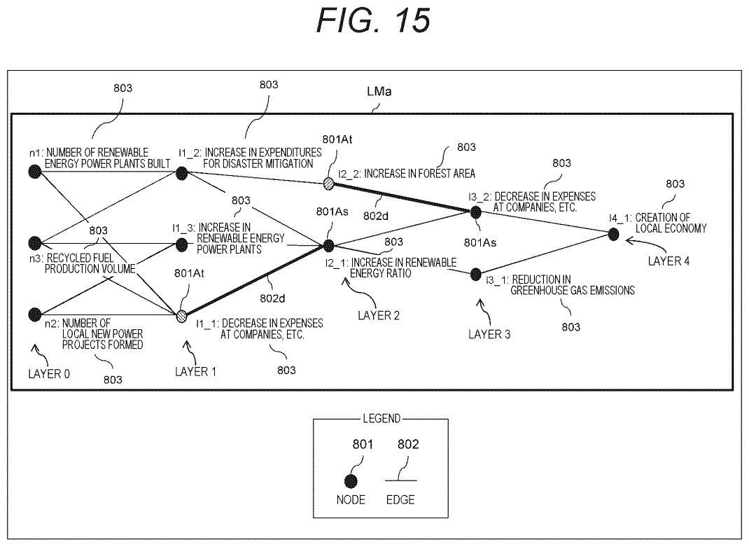

FIG. 15 is an explanatory diagram showing a fifth example of the logic model LM. FIG. 15 is a display example in which the dissimilarity display example shown in FIG. 13 and the dissimilarity display example shown in FIG. 14 are combined. Accordingly, it is possible to easily visually recognize which node of the target node 801At and the source node 801As at both ends of the dissimilarity display target edge 802d has dissimilarity in the logic model LMB of the user B.

As described above, according to the present embodiment, it is possible to support the preparation of the logic model LM and improve the efficiency of the preparation of the logic model by the user 120. Accordingly, it is possible to facilitate and speed up the determination of measures. In addition, by comparing the logic models LM of the respective users 120, it is possible to clarify a difference in an index to be used for each user 120.

In addition, the above-described logic model preparation support device 101 can also be configured as in the following (1) to (8).

(1) A logic model preparation support device 101 includes: a storage unit 500 configured to store a logic model being a network structure including at least one node having an index and an edge indicating a connection of indexes indicated by two of the at least one node; an input unit 501 configured to input a first node and a first edge; a generation unit 502 configured to generate a first logic model based on a first node and a first edge input by the input unit 501; an identification unit 504 configured to identify a similarity index similar to a first index of the first node from the logic model when the first node in a first logic model generated by the generation unit 502 is specified; and an output unit 503 configured to output a similarity index identified by the identification unit 504.

(2) In the logic model preparation support device 101 of (1), the storage unit 500 stores related information related to the index, and the output unit 503 outputs the similarity index and information related to the similarity index.

(3) In the logic model preparation support device 101 of (1), when the first edge in the first logic model is specified, the identification unit 504 identifies the similarity index similar to the first index of the first edge connected to the first edge from the logic model.

(4) In the logic model preparation support device 101 of (1), the storage unit 500 stores a learning model trained by using the logic model as training data and using presence or absence of using the logic model as correct answer data, and when output data output by inputting the first logic model to the learning model indicates use of the first logic model, the identification unit 504 identifies the similarity index from the logic model that has become the training data of the learning model.

(5) In the logic model preparation support device 101 of (1), the input unit 501 inputs a second node and a second edge, the generation unit 502 generates a second logic model based on a second node and a second edge input by the input unit 501, when a second index similar to the first index of the first node in the first logic model is not present in any of the second nodes of the second logic model, the identification unit 504 determines the first node as a specific first node in which the first index is not similar to the second index, and the output unit 503 outputs the specific first node in the first logic model in a displayable manner to an output destination (terminal 102) of the first logic model so as to be different from another first node that is not the specific first node.

(6) In the logic model preparation support device 101 of (1), the input unit 501 inputs a second node and a second edge, the generation unit 502 generates a second logic model based on a second node and a second edge input by the input unit 501, the identification unit 504 identifies a similarity second node having a second index similar to the first index of the first node in the first logic model from the second logic model, and when the first index of a first node of a connection destination connected to the first node by the first edge is not similar to the second index of a second node of a connection destination connected to the similarity second node second edge, the identification unit 504 determines the first edge connecting the first node and a first node of the connection destination as a specific first edge, and in the first logic model, the output unit 503 outputs the specific first edge in a displayable manner to an output destination (terminal 102) of the first logic model so as to be different from another first edge that is not the specific first edge.

(7) In the logic model preparation support device 101 of (6), the identification unit 504 determines a first node of the connection destination as a specific first node in which the first index is not similar to the second index, and in the first logic model, the output unit 503 outputs the specific first node in a displayable manner to an output destination (terminal 102) of the first logic model so as to be different from another first node that is not the specific first node.

(8) In the logic model preparation support device 101 of (1), the input unit 501 inputs a second node and a second edge, the generation unit 502 generates a second logic model based on a second node and a second edge input by the input unit 501, the identification unit 504 identifies a dissimilarity second node having a second index that is not similar to the first index of the first node in the first logic model from the second logic model, and when the first index of a first node of a connection destination connected to the first node by the first edge is not similar to the second index of a second node of a connection destination connected to the similarity second node with the second edge, the identification unit 504 determines the first edge connecting the first node and a first node of the connection destination as a specific first edge, and in the first logic model, the output unit 503 outputs the specific first edge in a displayable manner to an output destination of the first logic model so as to be different from another first edge that is not the specific first edge.

(9) In the logic model preparation support device 101 of (8), the identification unit 504 determines the first node and a first node of the connection destination as a specific first node in which the first index is not similar to the second index, and in the first logic model, the output unit 503 outputs the specific first node in a displayable manner to an output destination of the first logic model so as to be different from another first node that is not the specific first node.

(10) In the logic model preparation support device 101 of (1), the input unit 501 inputs a layer of the first node, the generation unit 502 generates the first logic model in which the first node is arranged by the layer based on the first node, the first edge, and the layer, and the output unit 503 outputs the first logic model in which the first node is arranged by the layer.

It should be noted that the present invention is not limited to the above-described embodiments, and includes various modifications and equivalent configurations within the spirit of the appended claims. For example, the above-described embodiments have been described in detail for easy understanding of the present invention, and the present invention is not necessarily limited to those having all the described configurations. In addition, a part of the configuration of a certain embodiment may be replaced with the configuration of another embodiment. In addition, the configuration of another embodiment may be added to the configuration of a certain embodiment. In addition, a part of the configuration of each embodiment may be added, deleted, or replaced with another configuration.

In addition, a part or all of the above-described each configuration, function, processing unit, processing means, and the like may be implemented by hardware by, for example, designing with an integrated circuit, or may be implemented by software by a processor interpreting and executing a program for implementing each function.

Information such as a program, a table, and a file for implementing each function can be stored in a storage device such as a memory, a hard disk, and a solid-state drive (SSD), or a recording medium such as an integrated circuit (IC) card, an SD card, and a digital versatile disc (DVD).

In addition, the control lines and the information lines indicate those which are considered necessary for the description, and do not necessarily indicate all the control lines and the information lines on the product. Actually, it can be considered that almost all configurations are connected to each other.

1. A logic model preparation support device comprising:
a storage unit configured to store a logic model being a network structure including at least one node having an index and an edge indicating a connection of indexes indicated by two of the at least one node;
an input unit configured to input a first node and a first edge;
a generation unit configured to generate a first logic model based on a first node and a first edge input by the input unit;
an identification unit configured to identify a similarity index similar to a first index of the first node from the logic model when the first node in a first logic model generated by the generation unit is specified; and
an output unit configured to output a similarity index identified by the identification unit.

2. The logic model preparation support device according to claim 1,
wherein the storage unit stores related information related to the index, and
wherein the output unit outputs the similarity index and information related to the similarity index.

3. The logic model preparation support device according to claim 1,
wherein when the first edge in the first logic model is specified, the identification unit identifies the similarity index similar to the first index of the first edge connected to the first edge from the logic model.

4. The logic model preparation support device according to claim 1,
wherein the storage unit stores a learning model trained by using the logic model as training data and using presence or absence of using the logic model as correct answer data, and
wherein when output data output by inputting the first logic model to the learning model indicates use of the first logic model, the identification unit identifies the similarity index from the logic model that has become the training data of the learning model.

5. The logic model preparation support device according to claim 1,
wherein the input unit inputs a second node and a second edge,
wherein the generation unit generates a second logic model based on a second node and a second edge input by the input unit,
wherein when a second index similar to the first index of the first node in the first logic model is not present in any of the second nodes of the second logic model, the identification unit determines the first node as a specific first node in which the first index is not similar to the second index, and
wherein the output unit outputs the specific first node in the first logic model in a displayable manner to an output destination of the first logic model so as to be different from another first node that is not the specific first node.

6. The logic model preparation support device according to claim 1,
wherein the input unit inputs a second node and a second edge,
wherein the generation unit generates a second logic model based on a second node and a second edge input by the input unit,
wherein the identification unit identifies a similarity second node having a second index similar to the first index of the first node in the first logic model from the second logic model, and when the first index of a first node of a connection destination connected to the first node by the first edge is not similar to the second index of a second node of a connection destination connected to the similarity second node by the second edge, the identification unit determines the first edge connecting the first node and a first node of the connection destination as a specific first edge, and
wherein in the first logic model, the output unit outputs the specific first edge in a displayable manner to an output destination of the first logic model so as to be different from another first edge that is not the specific first edge.

7. The logic model preparation support device according to claim 6,
wherein the identification unit determines a first node of the connection destination as a specific first node in which the first index is not similar to the second index, and
wherein in the first logic model, the output unit outputs the specific first node in a displayable manner to an output destination of the first logic model so as to be different from another first node that is not the specific first node.

8. The logic model preparation support device according to claim 1,
wherein the input unit inputs a second node and a second edge,
wherein the generation unit generates a second logic model based on a second node and a second edge input by the input unit,
wherein the identification unit identifies a dissimilarity second node having a second index that is not similar to the first index of the first node in the first logic model from the second logic model, and when the first index of a first node of a connection destination connected to the first node by the first edge is not similar to the second index of a second node of a connection destination connected to the similarity second node with the second edge, the identification unit determines the first edge connecting the first node and a first node of the connection destination as a specific first edge, and
wherein in the logic model, the output unit outputs the specific first edge in a displayable manner to an output destination of the first logic model so as to be different from another first edge that is not the specific first edge.

9. The logic model preparation support device according to claim 8,
wherein the identification unit determines the first node and a first node of the connection destination as a specific first node in which the first index is not similar to the second index, and
wherein in the first logic model, the output unit outputs the specific first node in a displayable manner to an output destination of the first logic model so as to be different from another first node that is not the specific first node.

10. The logic model preparation support device according to claim 1,
wherein the input unit inputs a layer of the first node,
wherein the generation unit generates the first logic model in which the first node is arranged by the layer based on the first node, the first edge, and the layer, and
wherein the output unit outputs the first logic model in which the first node is arranged by the layer.

11. A logic model preparation support method by a computer including a processor that executes a program and a storage device that stores the program, the logic model preparation support method comprising:
enabling the processor to access a database storing a logic model that is a network structure including at least one node having an index and an edge indicating a connection of indexes indicated by two of the at least one node; and
causing the processor to:
input a first node and a first edge,
generate a first logic model based on the first node and the first edge,
when the first node in the first logic model is specified, identify a similarity index similar to a first index of the first node from the logic model, and
output the similarity index.

12. A logic model preparation support program causing a processor, the processor enabled to access a database that stores a logic model that is a network structure including at least one node having an index and an edge indicating a connection of indexes indicated by two of the at least one node, to execute processing of:
inputting a first node and a first edge;
generating a first logic model based on the first node and the first edge;
when the first node in the first logic model is specified, identifying a similarity index similar to a first index of the first node from the logic model; and
outputting the similarity index.
